(19) United States
(12) Patent Application Publication
(10) Pub. No.: US 2017/0324799 A1
(43) Pub. Date: Nov. 9, 2017

(54) AUGMENTED NEWS FEED IN AN ON-LINE SOCIAL NETWORK

(71) Applicant: Linkedin Corporation, Mountain View, CA (US)

(72) Inventors: Guy Lebanon, Menlo Park, CA (US); Zheng Li, San Jose, CA (US); Ying Xuan, Sunnyvale, CA (US); Nikita Igorevych Lytkin, Sunnyvale, CA (US)

(21) Appl. No.: 15/149,418

(22) Filed: May 9, 2016

(51) Int. Cl. H04L 29/08; G06F 17/30; H04L 12/26

(52) U.S. Cl. CPC H04L 67/02; H04L 67/306; H04L 43/16; G06F 17/30368; G06F 17/3053; G06F 17/30864

(57) ABSTRACT

A news feed system is provided to generate augmented news feed for a member of an on-line social network. When a request is detected to construct a news feed for a member in an on-line social network system, the news feed system determines a cohort of the member and, from the updates that are being presented in their respective news feeds to members of the cohort, selects a leaderboard set of updates. The leaderboard set of updates is used in constructing a news feed web page for the member.

### TECHNICAL FIELD

This application relates to the technical fields of software and/or hardware technology and, in one example embodiment, to system and method to generate augmented news feed in an on-line social network.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be include one or more web pages, or a structured representation of the member's information in XML (Extensible Markup Language), JSON (JavaScript Object Notation), etc. A member's profile web page of a social networking web site may emphasize employment history and education of the associated member.

A member of on-line social network may be permitted to share information with other members by posting an update that would appear on respective news feed pages of the other members. An update may be an original message, a link to an on-line publication, a re-share of a post by another member, etc. Members that are presented with such an update on their news feed page may choose to indicate that they like the post, may be permitted to contribute a comment, etc.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate augmented news feed in an on-line social network may be implemented;

FIG. 2 is block diagram of a system to generate augmented news feed in an on-line social network, in accordance with one example embodiment;

FIG. 3 is a flow chart of a method to generate augmented news feed in an on-line social network, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to generate augmented news feed in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). The profile information of a social network member may include personal information such as, e.g., the name of the member, current and previous geographic location of the member, current and previous employment information of the member, information related to education of the member, information about professional accomplishments of the member, publications, patents, etc. The profile of a member may also include information about the member's current and past employment, such as company identifications, professional titles held by the associated member at the respective companies, as well as the member's dates of employment at those companies. As mentioned above, an on-line social networking system may be designed to allow registered members to establish and document networks of people they know and trust professionally.

A member profile is also associated with social links that indicate the associated member's connection to other members of the social network. Any two members of a social network may indicate their mutual willingness to be “connected” in the context of the social network, in that they can view each other's profiles, receive notifications of each other's posts and status changes, and otherwise be in touch via the social network. Members that are connected in this way to a particular member may be referred to as that particular member's connections or as that particular member's network. Respective profiles of two members who are each other's connections are associated with respective links indicative of such reciprocal connection. The on-line social network system, in some embodiments, also permits a one-sided connection, where a member is permitted to follow another member or another entity, such as a company, a university, etc. When a member follows another member or entity, that member's profile is associated with a link indicative of a one-sided connection, where, e.g., the member receives updates regarding the other member or the entity that the member follows.

The updates, posts, and other information regarding a member's connection may be presented as part of the member's so-called news feed. A news feed may be provided to a member on a dedicated web page, e.g., on a home page of the member in the on-line social network. A news feed page is generated by for each member by a news feed system provided with the on-line social network system and includes items that has been determined as being potentially of interest to that member. Examples of items in the news feed generated for a member are posts and news with respect to the connections of that member and the entities that the member is following, as well as job postings that have been determined as relevant to the member. As there may be a rather large inventory of updates available for inclusion into a member's news feed, the news feed system is configured to select a subset of all available updates for inclusion into the news feed. Such selection maybe based on various selection criteria, such as, e.g., the degree of relevance of an update item with respect to the member, the degree of connection between the member and the source of the update, etc.

In some scenarios, e.g., where a member has few connections and does not follow many or any other members or entities, it may be beneficial to increase inventory of available updates for that member by reaching outside the member's network. A member, for whom the news feed is being created, may be referred to as a focus member to distinguish that member from other members who are not the focus of our attention at the moment. The news feed generated for a focus member may be augmented by including, into the pool of items that are being considered for insertion into the news feed, items that are popular in the on-line social network in general or, specifically, among members of the focus member's cohort (i.e., among members whose profiles are in some way similar to the profile representing the focus member). A group of profiles, for which profiles have been selected based on one or more characteristics, is termed a cohort for the purposes of this description. A cohort may be identified based on a particular industry, where all profiles in the cohort indicate that the members represented by the respective profiles are associated with that particular industry. Other examples of cohorts are those identified as cohorts based on a particular company, a set of skills, or a country, where all profiles in the cohort indicate that the members represented by the respective profiles are associated with that company, with that set of skills, with that country, or any combination of those.

Updates that are being considered for insertion into a member's news feed in the on-line social network may originate from various sources, such as, e.g., posts by members who are connections of the focus member (either mutual connections or entities that is being followed by the focus member), news with respect to members who are connections of the focus member, job postings, etc. Updates from a source is first ranked based on a predetermined criteria, and then a subset of highest-ranked update items is provided to an second pass ranker to be ranked together with the updates from other sources. For example, from all job postings available in the on-line social network system, only those sufficiently relevant to the focus member are provided to the second pass ranker. From all news articles available in the on-line social network system, only a subset is provided to the second pass ranker. The second pass ranker, which may be part of the news feed system, processes the inventory of updates received from multiple sources for the focus member to select a final set of updates, which is then included in the news feed web page that is being generated for the focus member. The second pass ranker may rank the items in the inventory of updates utilizing, e.g., a statistical model, such as logistic regression, based on a set of attributes describing each item and the focus member. Such attributes may include the type of the item (e.g., job recommendation, connection recommendation, news article share, etc.), focus member's past counts of interactions with items of this type, profile attributes of the focus member (e.g., skills, industry, education, etc.), as well as profile attributes of the member whose activity resulted in generation of this item (e.g., member article share), etc.

In some embodiments, an additional source of updates that the news feed system is utilizing to increase inventory of available updates for a member who has few connections and does not follow many other members or entities is a so-called leaderboard. Including, into the inventory of updates, updates from leaderboard, may be beneficial in encouraging engagement of a member with the on-line social network system. A leaderboard is a source of updates that do not originate from the network of the focus member, but has been recognized as potentially relevant to the focus member based on their popularity with members of the focus member's cohort. The news feed system configured to augment a news feed for a member as described herein may be referred to as a system for generating augmented news feed for a member of an on-line social networking system may be part of the news feed system mentioned above.

In operation, when a request is detected to construct a news feed for a focus member represented by a focus profile in an on-line social network system, the news feed system determines a cohort of the focus member. From the updates that are being presented in their respective news feeds to members of the cohort, the news feed system selects a subset, termed a leaderboard set of updates, based on the respective popularity of the updates with the members of the cohort. Popularity of an update with the members of the cohort may be determined, e.g., based on its click through rate (CTR), based on a ratio between CTR and the number of impressions for the update, and/or other metrics. In some embodiments, the news feed system first determines popularity of updates by measuring a degree of association between engagement with respective updates within the cohort and engagement with the updates outside the cohort, then filters out those updates that are not characterized by a greater engagement among members within the cohort than outside the cohort, and then calculates popularity of the remaining updates based on CTR etc.

The leaderboard set of updates is then included with the rest of the inventory of updates that are available for the focus member for the final pass ranking by the second pass ranker. The second pass ranker generates a rank for each update in an inventory of updates and a final subset of updates is generated based on the respective generated ranks for each update in the inventory of updates. The news feed system then constructs a news feed web page that includes the final subset of updates and causes presentation of the news feed page on a display device of the focus member.

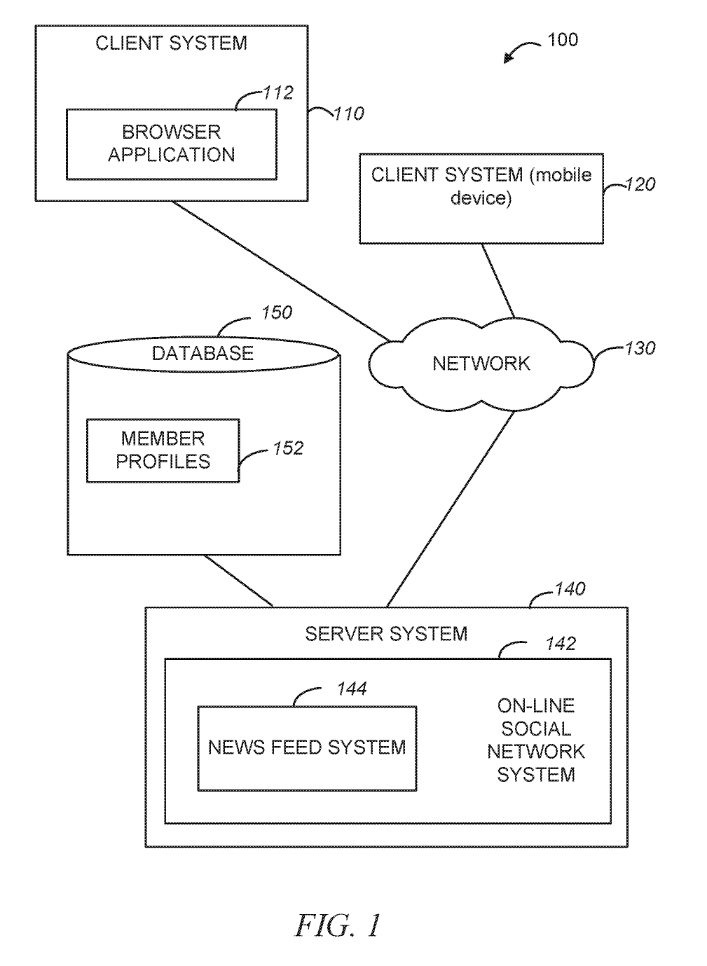

Example method and system to generate augmented news feed in an on-line social network may be implemented in the context of a network environment 100 illustrated in FIG. 1. As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other members in the on-line social network. Member profiles and related information may be stored in a database 150 as member profiles 152.

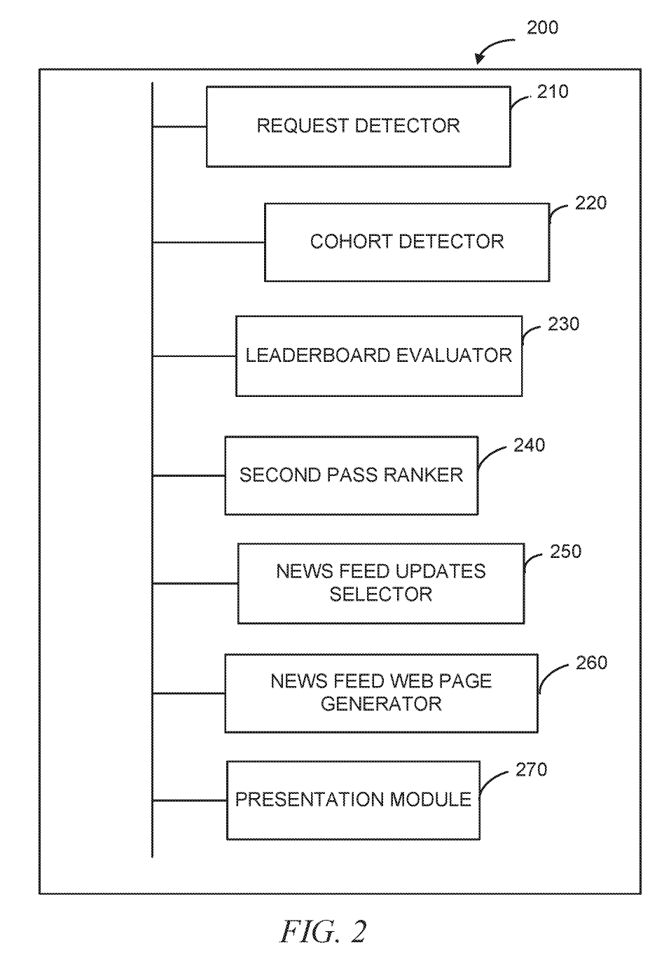

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a news feed system 144. The news feed system 144 may be configured to generate augmented news feed for a member of an on-line social network, e.g., utilizing the methodologies described herein. When a request is detected to construct a news feed for a member in an on-line social network system, the news feed system determines a cohort of the member and, from the updates that are being presented in their respective news feeds to members of the cohort, selects a leaderboard set of updates. One or more updates from the leaderboard set of updates are then included in a news feed web page for the member. As mentioned above, in some embodiments, updates from leaderboard are used for members that do not have a large inventory of updates. An example news feed system 144 is illustrated in FIG. 2.

FIG. 2 is a block diagram of a system 200 to generate augmented news feed in an on-line social network, in accordance with one example embodiment. As shown in FIG. 2, the system 200 includes a request detector 210, a cohort detector 220, a leaderboard evaluator 230, a second pass ranker 240, and a news feed updates selector 250. The request detector 210 is configured to detect a request to generate a news feed web page for a focus member represented by a focus profile in the on-line social network system 142. The focus profile is associated with one or more links representing respective connections between the focus profile and profiles of connections of the focus member in the on-line social network system 142. The cohort detector 220 is configured to identify a cohort associated with the focus profile. As explained above, the cohort comprises those member profiles in the on-line social network system 142 that are characterized by a set of defining features, such as, e.g., a particular industry, a particular company, a certain set of skills, etc. A member profile may be associated with more than one cohort.

The leaderboard evaluator 230 is configured to evaluate additional updates that are being presented to cohort members represented by profiles from the cohort and select a leaderboard set of updates from the additional updates based on their respective popularity with the cohort members. Popularity of an update with the members of the cohort may be determined, e.g., based on its click through rate (CTR), based on a ratio between CRT and the number of impressions for the update, and/or other metrics. The leaderboard set of updates is then included with the rest of the inventory of updates that are available for the focus member for the final pass ranking by the second pass ranker 240. The second pass ranker 240 is configured to generate a rank for each update in the inventory of updates. As explained above the inventory of updates for a member may originate from various sources, such as updates from the connections of the member and job postings. The inventory of updates for a member may be augmented with the leaderboard set of updates. When a member profile is associated with multiple cohorts, additional updates from multiple leaderboard sources may be included in the inventory of updates that is processed by the second pass ranker 240. As mentioned above, the system 200 may be configured to augment inventory of updates with updates that originate from one or more leaderboards in response to determining that the focus profile is associated with a number of connection links below a threshold value.

The news feed updates selector 250 is configured to generate a final subset of updates based on the respective generated ranks for each update in the inventory of updates.

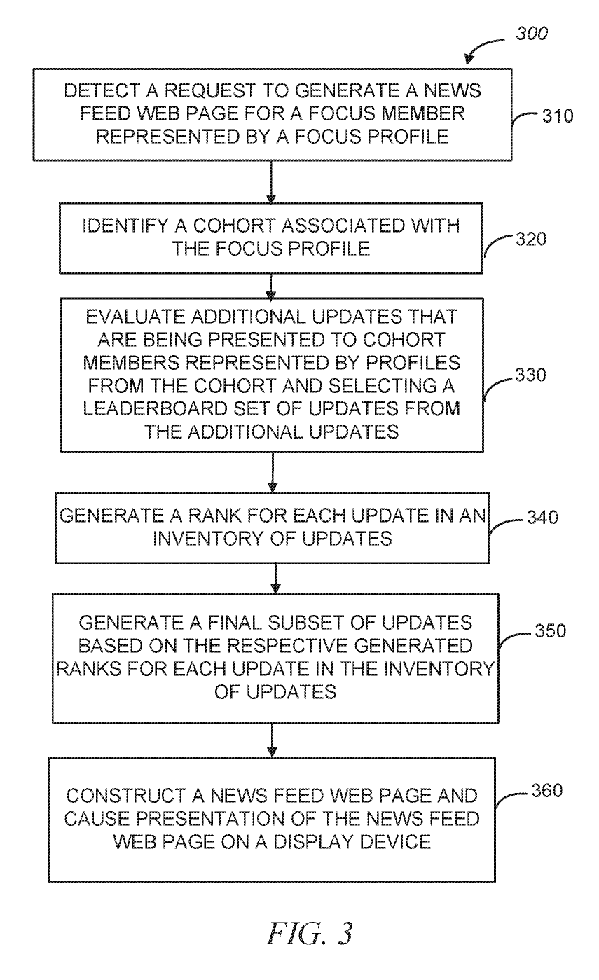

Also shown in FIG. 2 are a news feed web page generator 260 and a presentation module 270. The news feed web page generator 260 is configured to construct a news feed web page that includes the final subset of updates produced by the news feed updates selector 250 based on the respective generated ranks for each update in the inventory of updates. The presentation module 270 is configured to cause presentation of the news feed web page on a display device of the focus member. Some operations performed by the system 200 may be described with reference to FIG. 3.

FIG. 3 is a flow chart of a method 300 to generate augmented news feed in an on-line social network for a member, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the request detector 210 of FIG. 2 detects a request to generate a news feed web page for a focus member represented by a focus profile in the on-line social network system 142. The focus profile is associated with one or more links representing respective connections between the focus profile and profiles of connections of the focus member in the on-line social network system 142. At operation 320, the cohort detector 220 of FIG. 2 identifies a cohort associated with the focus profile. The leaderboard evaluator 230 of FIG. 2 evaluates additional updates that are being presented to cohort members represented by profiles from the cohort and selects a leaderboard set of updates from the additional updates based on their respective popularity with the cohort members, at operation 330. At operation 340, the second pass ranker 240 of FIG. 2 generates a rank for each update in the inventory of updates. As explained above, the inventory of updates for the focus member may originate from various sources, such as updates from the connections of the member and job postings and may be augmented with the leaderboard set of updates.

The news feed updates selector 250 of FIG. 2 generates a final subset of updates, at operation 350, based on the respective generated ranks for each update in the inventory of updates. The news feed web page generator 260 of FIG. 2 constructs a news feed web page that includes the final subset of updates produced by the news feed updates selector 250 and the presentation module 270 of FIG. 2 causes presentation of the news feed web page on a display device of the focus member, at operation 360.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

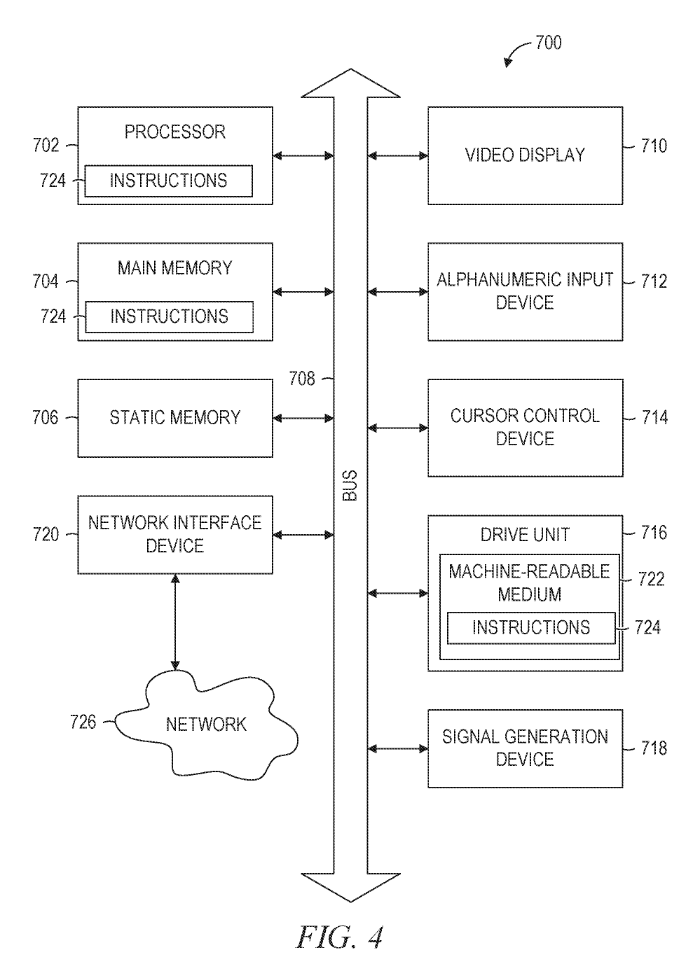

FIG. 4 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to generate augmented news feed in an on-line social network have been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A method comprising:
detecting a request to generate a news feed web page for a focus member represented by a focus profile in an on-line social network system, the focus profile associated with one or more links representing respective connections between the focus profile and profiles of connections of the focus member in the on-line social network system;
identifying a cohort associated with the focus profile, the cohort comprising those member profiles in the on-line social network system that are characterized by a set of defining features;
using at least one processor, evaluating additional updates that are being presented to cohort members represented by profiles from the cohort and selecting a leaderboard set of updates from the additional updates based on their respective popularity with the cohort members;
generating a rank for each update in an inventory of updates, the inventory of updates comprising the leaderboard set of updates and updates from the connections of the focus member; and
generating a final subset of updates based on the respective generated ranks for each update in the inventory of updates.

2. The method of claim 1, comprising constructing a news feed web page that includes the final subset of updates.

3. The method of claim 1, comprising causing presentation of the news feed web page on a display device of the focus member.

4. The method of claim 1, comprising determining popularity of an update from the additional updates by measuring a degree of association between engagement with the update within the cohort and engagement with the update outside the cohort.

5. The method of claim 1, comprising determining popularity of an update from the additional updates based on a click through rate associated with the update.

6. The method of claim 1, comprising determining popularity of an update from the additional updates based on a ratio of a click through rate associated with the update and a number of impressions associated with the update.

7. The method of claim 1, wherein the evaluating of the additional updates is in response to determining that the focus profile is associated with a number of connection links below a threshold value.

8. The method of claim 1, wherein the focus profile is associated with a plurality of cohorts, the cohort being from the plurality of cohorts.

9. The method of claim 1, wherein a feature from the set of defining features represents an industry indicated in the focus profile.

10. The method of claim 1, wherein a feature from the set of defining features represents a company indicated in the focus profile.

11. A computer-implemented system comprising:
a request detector, implemented using at least one processor, to detect a request to generate a news feed web page for a focus member represented by a focus profile in an on-line social network system, the focus profile associated with one or more links representing respective connections between the focus profile and profiles of connections of the focus member in the on-line social network system;
a cohort detector, implemented using at least one processor, to identify a cohort associated with the focus profile, the cohort comprising those member profiles in the on-line social network system that are characterized by a set of defining features;
a leaderboard evaluator, implemented using at least one processor, to evaluate additional updates that are being presented to cohort members represented by profiles from the cohort and select a leaderboard set of updates from the additional updates based on their respective popularity with the cohort members;
a second pass ranker, implemented using at least one processor, to generate a rank for each update in an inventory of updates, the inventory of updates comprising the leaderboard set of updates and updates from the connections of the focus member; and
a news feed updates selector, implemented using at least one processor, to generate a final subset of updates based on the respective generated ranks for each update in the inventory of updates.

12. The system of claim 11, comprising a news feed web page generator, implemented using at least one processor, to construct a news feed web page that includes the final subset of updates.

13. The system of claim 11, comprising a presentation module, implemented using at least one processor, to cause presentation of the news feed web page on a display device of the focus member.

14. The system of claim 11, wherein the leaderboard evaluator is to measure a degree of association between engagement with the update within the cohort and engagement with the update outside the cohort.

15. The system of claim 11, wherein the leaderboard evaluator is to determine popularity of an update from the additional updates based on a click through rate associated with the update.

16. The system of claim 11, wherein the leaderboard evaluator is to determine popularity of an update from the additional updates based on a ratio of a click through rate associated with the update and a number of impressions associated with the update.

17. The system of claim 11, wherein the leaderboard evaluator is to evaluate the additional updates in response to determining that the focus profile is associated with a number of connection links below a threshold value.

18. The system of claim 11, wherein the focus profile is associated with a plurality of cohorts, the cohort being from the plurality of cohorts.

19. The system of claim 11, wherein a feature from the set of defining features represents an industry or a company indicated in the focus profile.

20. A machine-readable non-transitory storage medium having instruction data executable by a machine to cause the machine to perform operations comprising:
detecting a request to generate a news feed web page for a focus member represented by a focus profile in an on-line social network system, the focus profile associated with one or more links representing respective connections between the focus profile and profiles of connections of the focus member in the on-line social network system;
identifying a cohort associated with the focus profile, the cohort comprising those member profiles in the on-line social network system that are characterized by a set of defining features;
evaluating additional updates that are being presented to cohort members represented by profiles from the cohort and selecting a leaderboard set of updates from the additional updates based on their respective popularity with the cohort members;
generating a rank for each update in an inventory of updates, the inventory of updates comprising the leaderboard set of updates and updates from the connections of the focus member; and
generating a final subset of updates based on the respective generated ranks for each update in the inventory of updates.
